(19) United States
(12) Patent Application Publication
(10) Pub. No.: US 2016/0024998 A1
(43) Pub. Date: Jan. 28, 2016

(54) A COMPACT ROTARY WASTEGATE VALVE

(71) Applicant: BORGWARNER INC., Auburn Hills, MI (US)

(72) Inventors: Andrew DAY, Huddersfield (GB); Mark BURGESS, Skipton (GB); Adam SAMUELS, Prestwich, Manchester (GB)

(73) Assignee: BorgWarner Inc., Auburn Hills, MI (US)

(21) Appl. No.: 14/774,953

(22) PCT Filed: Mar. 12, 2014
(86) PCT No.: PCT/US2014/024319

§ 371 Date: Sep. 11, 2015

Related U.S. Application Data
(60) Provisional application No. 61/786,789, filed on Mar. 15, 2013.

(51) Int. Cl. F02B 37/22; F01D 5/02; F01D 25/24; F02B 33/40

(52) U.S. Cl. CPC F02B 37/225; F02B 33/40; F01D 5/02; F01D 25/24; F05D 2220/40; F05D 2240/24

(57) ABSTRACT

A turbocharger includes a turbine section and a compressor section. The turbine section includes a turbine housing (1) that surrounds a turbine wheel (15). The turbine housing (1) defines an exhaust gas inlet (2), a duct (6) that extends between the inlet (2) and the turbine wheel (15), and a wastegate opening (5) in the duct (6). A, butterfly-type wastegate valve (3) including a valve plate (10) and a rotatable shaft (11) is disposed in the opening (5) and rotates between an open position and a closed position. A spring (4) is attached to the shaft (11) to bias (4) the shaft (11) toward rotation about a longitudinal axis in a first direction; wherein pressure of a gas flowing in the exhaust duct (6) against the valve plate (10) causes a rotary motion of the valve plate (10) and rotatable shaft (11) against the spring bias in a second direction.

### CROSS-REFERENCE TO RELATED APPLICATIONS

The present invention claims priority under 35 USC 119 based on U.S. Provisional patent application No. 61/786,789, filed on Mar. 15, 2013. The subject matter of this priority document is incorporated by reference herein.

### BACKGROUND

1. Field of the Invention

This invention relates to a turbocharger for an internal combustion engine. More particularly, this invention relates to turbocharger having a rotary wastegate valve.

2. Description of Related Art

A turbocharger is a type of forced induction system used with internal combustion engines. Turbochargers deliver compressed air to an engine intake, allowing more fuel to be combusted, thus boosting an engine's horsepower without significantly increasing engine weight. Thus, turbochargers permit the use of smaller engines that develop the same amount of horsepower as larger, normally aspirated engines. Using a smaller engine in a vehicle has the desired effect of decreasing the mass of the vehicle, increasing performance, and enhancing fuel economy. Moreover, the use of turbochargers permits more complete combustion of the fuel delivered to the engine, which contributes to the highly desirable goal of a cleaner environment.

Turbochargers typically include a turbine housing connected to the engine's exhaust manifold, a compressor housing connected to the engine's intake manifold, and a center bearing housing coupling the turbine and compressor housings together. A turbine wheel in the turbine housing is rotatably driven by an inflow of exhaust gas supplied from the exhaust manifold. A shaft rotatably supported in the center bearing housing connects the turbine wheel to a compressor impeller in the compressor housing so that rotation of the turbine wheel causes rotation of the compressor impeller. The shaft connecting the turbine wheel and the compressor impeller defines an axis of rotation. As the compressor impeller rotates, it increases the air mass flow rate, airflow density and air pressure delivered to the engine's cylinders via the engine's intake manifold.

When the pressure of the exhaust gas is high, there may be more exhaust pressure than is required to provide the desired pressure boost. One solution for this problem is to divert exhaust gas away from the turbine wheel, when the exhaust gas pressure is high, so that the amount of exhaust gas reaching the turbine is the quantity needed to provide optimum pressure boost. A wastegate valve may be used to divert exhaust gases away from the turbine wheel. Diversion of exhaust gases controls the turbine speed, which in turn controls the rotation speed of the compressor. By controlling the rotation speed of the compressor the wastegate is able to regulate the maximum boost pressure in turbocharger systems.

Some conventional turbochargers use a control mechanism to control the wastegate valve. For example, the control mechanism causes the wastegate valve to open when exhaust gas pressure is high, and close when exhaust gas pressure drops. The wastegate valve can be controlled based on the intake manifold pressure. Various mechanical devices have been used to open the wastegate when the pressure at the outlet of the turbocharger is high. Electrical control methods have also been used.

### SUMMARY OF THE INVENTION

In some aspects, a turbocharger includes a compressor section driven by a turbocharger section. The turbocharger section includes a turbine housing that surrounds a turbine wheel, and the turbine housing defines an exhaust gas inlet, a duct that extends between the inlet and the turbine wheel, and an opening in the duct. An actuator-free, exhaust gas pressure-actuated, butterfly valve is disposed in the opening and rotates between an open position and a closed position. The valve includes a rotatable shaft having a longitudinal axis, a valve plate secured to the shaft along a non-diameter chord of the valve plate; and a spring attached to the rotatable shaft in a manner such that the spring biases the shaft toward rotation about the longitudinal axis in a first direction; wherein pressure of a gas flowing in the exhaust duct against the valve plate causes a rotary motion of the valve plate and rotatable shaft against the spring bias.

The turbocharger may include one or more of the following features: The turbocharger further includes a spring tension adjustment device disposed on the duct and connected to the spring. The spring tension adjustment device is configured to permit adjustment of the tension of the spring. The spring is a coiled torsion spring. The spring tension adjustment device is a spring cover that is adjustably secured to a spring housing. One end of the spring is connected to the rotatable shaft and an other end of the spring is connected to the spring cover. The spring tension device is secured to the duct, and spring tension is adjusted by rotating the spring tension device relative to the duct.

The gas pressure-actuated, butterfly-style wastegate valve disclosed herein has an off-center mounted pivot shaft biased to a closed position by a coiled torsion spring, and provides readily adjustable control of exhaust gas pressure on the turbine wheel. Use of the wastegate valve provides adjustable control of the pressure boost which the turbocharger delivers to the intake manifold.

The gas pressure-actuated, butterfly-style wastegate valve described herein is controlled and actuated by turbine inlet pressure. As a result, conventional actuators and connecting mechanisms are not required, whereby valve structure is simplified and the turbocharger can be made more compact.

In some aspects, the actuator-free, gas pressure-actuated, butterfly-style valve, which includes an off-center mounted pivot shaft and a coiled torsion spring to preload the valve, may be used in the turbocharger output (e.g., on the compressor side) rather than on the turbine side, to bleed off extra pressure if the turbocharger provides too high a boost.

In some aspects, the spring is attached to the rotatable shaft in a manner such that the spring biases the shaft toward rotation about the longitudinal axis in a first direction; wherein pressure of a gas flowing in the exhaust duct against the disc causes a rotary motion of the disc and rotatable shaft against the spring bias. A spring cover connects the spring to the duct. The spring cover permits adjustment of the spring pre-load (e.g., bias) which holds the valve plate in the closed position, and is used to govern the point at which the turbine inlet pressure causes the valve to open, and thereby bypass exhaust gas. This arrangement has the following advantages:

It results in greatly reduced product complexity and cost relative to some turbochargers that include conventional wastegate valves;

An actuator bracket, hoses and connection to the turbocharger compressor cover that are used in some conventional wastegate valves are omitted, greatly improving packaging and reducing risk of component damage;

The exhaust gas leakage through a conventional wastegate bush is eliminated, thereby improving vehicle emissions;

The actuator-free exhaust gas pressure-actuated butterfly valve is fully sealed, eliminating the possibility of dust or water ingress;

The actuator-free exhaust gas pressure-actuated butterfly valve includes a valve plate that is off-center relative to the valve shaft, whereby the required actuation forces, and thus wear, are reduced;

Use of a butterfly-type wastegate valve rather than a conventional lift-type wastegate valve may combat valve sticking issues and reduce variability in valve closure force;

Elimination of an actuator-rod seals that are found in some conventional wastegate valves greatly reduces valve hysteresis;

The highly compact arrangement of the actuator-free exhaust gas pressure-actuated butterfly valve means that the bearing housing or compressor cover orientation relative to the turbine housing does not drive proliferation of actuator mounting and/or associated brackets;

Since the housing (e.g., the spring cover) containing the coiled spring can be rotated to any extent to govern the preload, proliferation is not necessary in terms of the spring preload and actuator rod length, etcetera; and

Elimination of an actuator diaphragm required in an actuator of some conventional wastegate valves results in increased durability.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 shows a turbine housing of a turbocharger including a closed wastegate valve formed in a gas inlet duct.

FIG. 2 shows the turbine housing of FIG. 1 with the wastegate valve in an open position.

FIG. 3 shows the turbine housing with a spring cover enclosing the coiled spring of the wastegate valve.

FIG. 4 shows a partially exploded view of the wastegate valve of FIG. 1 isolated from the turbine housing, including a valve disk, a valve shaft, a spring cover, and a coiled torsion spring.

FIG. 5 is a perspective view of the wastegate valve isolated from the turbine housing.

### DETAILED DESCRIPTION OF THE EMBODIMENTS

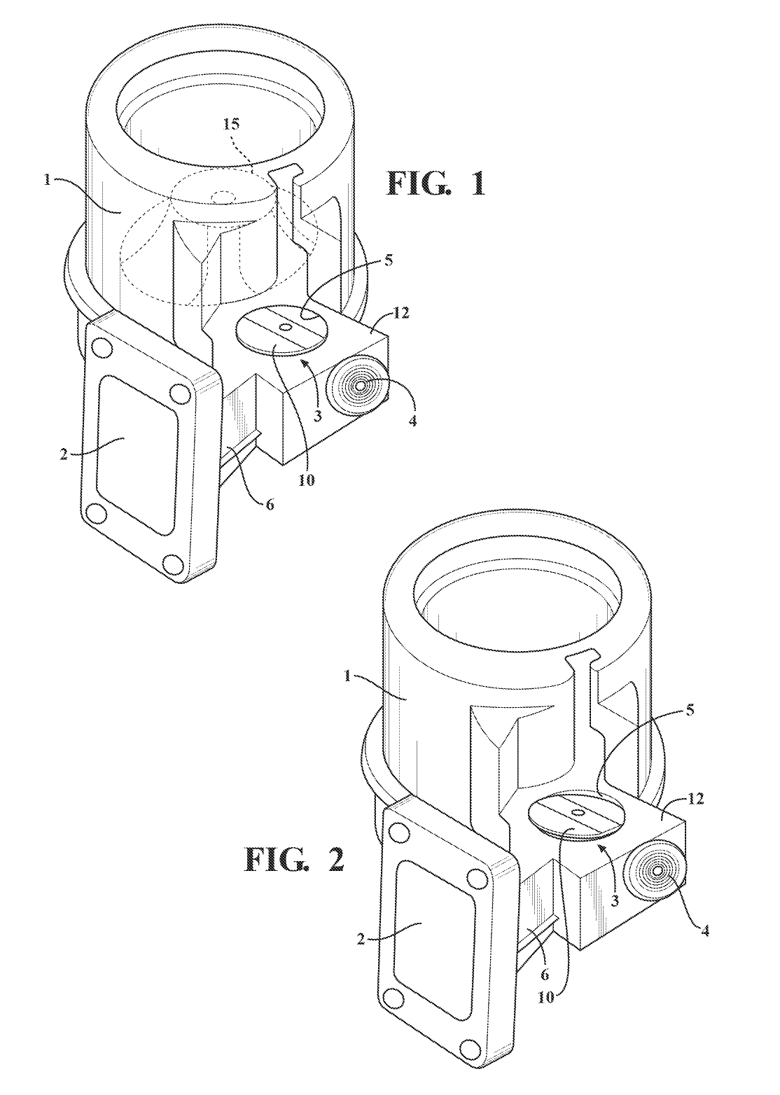

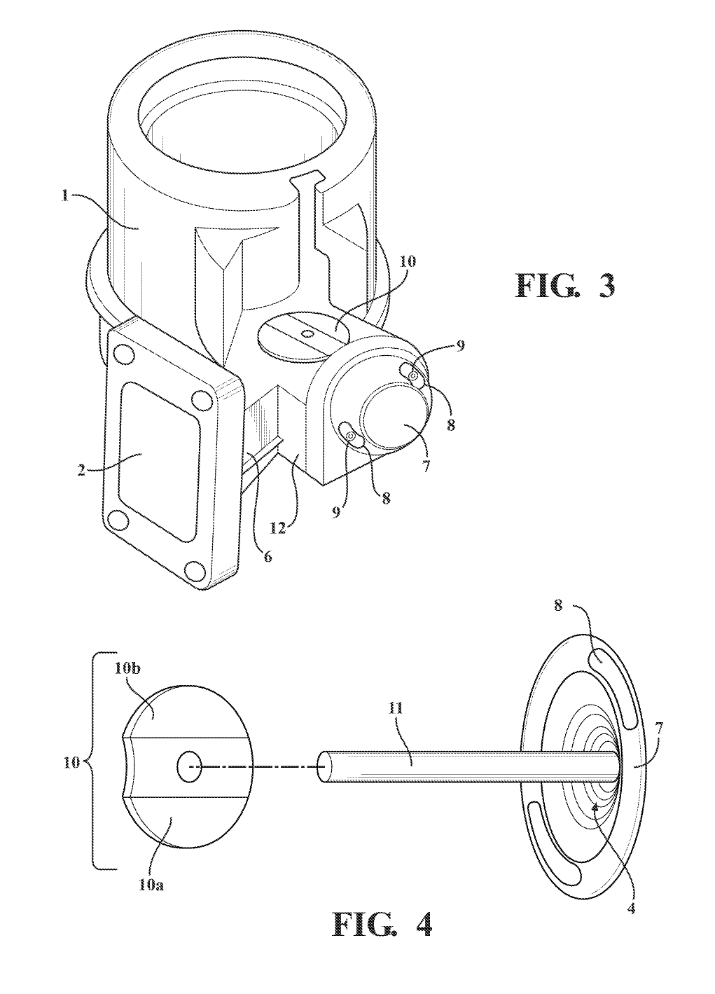

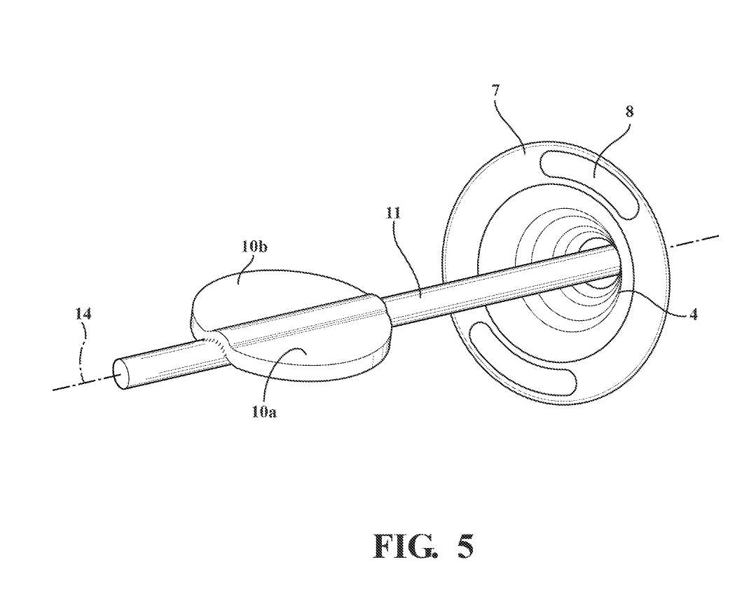

Referring to FIGS. 1-4, an exhaust gas turbocharger includes a compressor section (not shown) and a turbine section. The turbine section includes a turbine housing (1), and a turbine wheel (15) disposed in the turbine housing (1). The turbine housing (1) includes an exhaust gas inlet (2) that directs exhaust gas to the turbine wheel (15). A butterfly-type wastegate valve (3) is provided in an opening (5) formed in the duct portion (6) of the gas inlet (2). The opening (5) is a port formed in the duct portion (6) at a location upstream of the turbine wheel to permit venting of exhaust gas before it reaches the turbine wheel. The wastegate valve (3) controls the pressure boost provided by the turbocharger by controlling the pressure of the exhaust gas at the turbine wheel, as discussed further below.

The wastegate valve (3) includes a valve plate (10) and a valve shaft (11) that extends longitudinally along axis (14) and within a plane defined by the valve plate (10). The valve plate (10) is attached to the valve shaft (11), for example by welding. The valve plate (10) and valve shaft (11) are rotatably mounted within the duct portion (6) so that the valve plate 10 resides within the opening (5), and is movable between a closed position (FIG. 1) and an open position (FIG. 2). In the closed position, the valve plate (10) is rotated so as to lie in the plane defined by the opening (5), whereby the opening (5) is filled by the valve plate (10) and fluid (e.g., exhaust gas) is prevented from flowing through the opening (5). In the open position, the valve plate (10) is rotated so as to lie at an angle relative to the plane defined by the opening (5), whereby fluid can flow through the opening and turbine pressure is relieved. The valve shaft (11) is not centered on the valve plate (10). In particular, the shaft (11) does not extend along a diameter of the valve plate (10), and instead extends along a non-diameter chord of the valve plate (10). Accordingly, one side (10a) of the valve plate (10) is larger than the other side (10b).

The wastegate valve (3) includes a coiled torsion spring (4) supported adjacent the opening (5) within a spring housing (12). Although other types of springs could be employed, the coiled torsion-type spring is preferred because it is simple to install and does not require complex linkages to be effective. One end of the spring (4) is attached to the valve shaft (11), and an opposed end of the spring (4) is attached to a spring cover (7). The spring (4) is sandwiched between the spring housing (12) and the spring cover (7), and the spring cover (7) protects the spring (4) and is configured to permit adjustment of the tension of the spring (4), as discussed further below. The spring (4) provides a biasing force which holds the valve plate (10) in the closed position (FIG. 1) relative to the opening (5) until the exhaust gas pressure becomes high enough to overcome the spring force. When the exhaust gas pressure becomes high enough to overcome the spring force, the valve plate 10 and valve shaft 11 rotate within the duct (6), whereby the wastegate valve (3) moves to an open position (FIG. 2) relative to the opening (5). When the wastegate valve (3) opens, the excess exhaust gas bypasses the turbine wheel and goes directly to the exhaust system. This effectively limits the pressure of the exhaust gas in the turbocharger to a predetermined value.

Since one side (10a) of the valve plate (10) is larger than the other side (10b), the pressure of the exhaust gas does not act equally on the two sides of the valve plate (10). This creates a torque causing the wastegate valve (3) to open. The torque created by the exhaust gas is opposed by the spring (4). This arrangement keeps the wastegate valve (3) closed until the exhaust pressure is high enough to overcome the spring force. At exhaust gas pressures high enough to overcome the spring force of the spring (4), the valve opens and allows the exhaust gas to bypass the turbine. Thus, the spring properties and spring tension settings control the response of the valve (3) to exhaust gas pressure. If the pressure required to turn the valve shaft (11) against the spring (4) does not vary much with the degree of valve opening, the valve will function as a simple open or closed valve. If the pressure required to turn the valve shaft (11) against the coil torsion spring (4) varies with the degree of valve opening, then the valve (3) will provide a small opening at moderately elevated exhaust gas pressures, and a larger opening as the exhaust gas pressures increases.

The spring cover (7) includes elongated slots (8) formed along an outer edge thereof.

The spring cover (7) is secured to the spring housing (12) using screws (9) that extend through the slots (8). After slightly loosening the screws (9), the spring cover (7) may be turned (e.g., rotated) relative to the spring housing (12) about an axis of rotation (14) of the valve shaft (11). Since the spring (4) is connected to the spring cover (7), turning the spring cover (7) results in an adjustment of the tension of the spring (4). If the spring (4) tension is increased, it increases the exhaust gas pressure which is required to open the wastegate valve. This increases the upper limit on the pressure boost which the turbo charger will provide. Similarly, turning the cover to lessen tension on the spring (4) will lower the exhaust gas pressure which is required to open the valve. This decreases the upper limit on the pressure boost which the turbocharger will provide. Once the spring tension is at the desired force, the screws (9) are tightened. Thus, the spring cover (7) permits adjustment of the spring pre-load (e.g., bias) which holds the valve plate (10) in the closed position, and is used to govern the point at which the turbine inlet pressure causes the valve (3) to open, and thereby bypass exhaust gas.

The number of slots (8) in the spring cover can vary between 1 and 4. Two slots (8) are convenient. It is preferred that the slots (8) be placed symmetrically in the spring cover (7).

Although the valve (3) is described herein as disposed in the inlet (2) of the turbine section, the valve (3) is not limited to this implementation. For example, the butterfly-type valve (3) can be installed in the volute on the compressor side of the turbocharger. The preferred position is at the end of the compressor volute. In this position, it operates in the same manner as it does when placed in the turbine section exhaust inlet. In particular, the pressure of the compressed air does not act equally on the two sides of the valve plate (10). This creates a torque about the shaft (11), causing the butterfly valve to open. The torque created by the compressor exit gas is opposed by a coiled torsion spring (4) in the spring cover (7). This arrangement keeps the valve (3) closed until the compressor exit pressure is high enough to overcome the spring force of the spring (4). At compressor exit exhaust gas pressures high enough to overcome the spring force, the valve opens and allows the gas exiting the compressor to bypass the intake manifold of the engine. Thus, if the pressure of the compressed air exceeds a certain level, the valve (3) opens to release excessive pressure. This limits the pressure boost to a desired level.

What is claimed is:

1. A turbocharger comprising,
a turbine section including a turbine housing (1) that surrounds a turbine wheel (15), the turbine housing (1) defining an exhaust gas inlet (2), a duct (6) that extends between the inlet (2) and the turbine wheel (15), and an opening (5) in the duct (6),
an actuator-free, exhaust gas pressure-actuated, butterfly valve (3) disposed in the opening (5) and rotatable between an open position and a closed position, the valve (3) comprising:
a rotatable shaft (11) including a longitudinal axis (14),
a valve plate (10) secured to the shaft (11) along a non-diameter chord of the valve plate; and
a spring (4) attached to the rotatable shaft (11) in a manner such that the spring (4) biases the shaft (4) toward rotation about the longitudinal axis (14) in a first direction; wherein pressure of a gas flowing in the exhaust duct (6) against the valve plate (10) causes a rotary motion of the valve plate (10) and rotatable shaft (11) against the spring bias in a second direction opposite the first direction.

2. The turbocharger of claim 1, comprising a spring tension adjustment device (7, 12) disposed on the duct (6) and connected to the spring (4), the spring tension adjustment device (7, 12) configured to permit adjustment of the tension of the spring (4).

3. The turbocharger of claim 1, wherein the spring (4) is a coiled torsion spring.

4. The turbocharger of claim 2, wherein the spring tension adjustment device (7, 12) includes a spring cover (7) that is adjustably secured to a spring housing (12).

5. The turbocharger of claim 4, wherein one end of the spring (4) is connected to the rotatable shaft (11) and an other end of the spring is connected to the spring cover (7).

6. The turbocharger of claim 1, wherein the spring tension device (7, 12) is secured to the duct (6), and spring tension is adjusted by rotating the spring cover (7) device relative to the duct (6).
